(19) United States
(12) Patent Application Publication
(10) Pub. No.: US 2012/0030448 A1
(43) Pub. Date: Feb. 2, 2012

(54) SINGLE INSTRUCTION MULTIPLE DATE (SIMD) PROCESSOR HAVING A PLURALITY OF PROCESSING ELEMENTS INTERCONNECTED BY A RING BUS

(75) Inventor: Hanno Lieske, Tokyo (JP)

(73) Assignee: NEC CORPORATION, Tokyo (JP)

(21) Appl. No.: 13/203,809

(22) PCT Filed: Sep. 25, 2009
(86) PCT No.: PCT/JP2009/067282

§ 371 Date: Aug. 29, 2011

(30) Foreign Application Priority Data
Mar. 30, 2009 (JP) PCT/JP2009/057020

(51) Int. Cl. G06F 9/30; G06F 9/315; G06F 9/305

(52) U.S. Cl. 712/29; 712/E09.018; 712/E09.034; 712/E09.017

(57) ABSTRACT

A single instruction multiple data (SIMD) processor having a plurality of processing elements and including: a splitting unit for splitting an address of the read-only parameter data in the data memory into a first part and a second part at a bit position corresponding to the number of the processor elements; and a comparing unit for comparing the number of shifting, on a ring bus, of the read-only parameter data, which is taken from the internal memory at the address in accordance with the first part, with a difference between an own processor element position and a portion of the global address of the read-only parameter data to be accessed, the portion designating a position in the ring of the processor element in which the read-only parameter data to be accessed is stored and corresponding to the second part, to cause the other processor elements to take the read-only parameter data.

### TECHNICAL FIELD

The present invention relates to a data processing apparatus, a data processing system, and a data processing method.

### BACKGROUND ART

Processors that operate in a single instruction multiple data (SIMD) processing have been proposed (Patent Literature 1).

An example of such kind of SIMD architecture is described with reference to FIG. 15.

FIG. 15 is a conceptual block diagram illustrating the SIMD architecture.

As shown in FIG. 15, a SIMD architecture 90 includes a central processor (CP) 10, a plurality of processor elements (PE) 11, ring buses 12 and 13, and connections 14.

FIG. 15 illustrates 16 PEs 11 which are respectively identified as PE₀₀ to PE₁₅.

The CP-10 includes a data memory (DMEM) 16 which stores parameters, and the PEs 11 use the parameters for processing.

Each PE 11 has an internal memory (IMEM) 17 which stores the parameters transferred from the CP 10.

The CP 10 is connected to each PE 11 with the pipelined ring buses 12 and 13.

The CP 10 and each PE 11 are connected to the ring buses 12 and 13 through the connections 14.

Data is transferred between the CP 10 and each PE 11 in clockwise direction through the ring bus 12 and in anticlockwise direction through the ring bus 13.

In other words, data is transferred from the CP 10 to each PE 11 through the clockwise ring bus 12 and the anticlockwise ring bus 13.

Upon start of processing, each PE 11 takes parameters necessary for processing from the DMEM 16 of the CP 10.

Each PE 11 requests the parameters which are stored in the DMEM 16 of the CP 10, in the following general ways:

(1) Transfer on Request

(2) Preloading

In the case of above-mentioned (1) Transfer on request, each time the PE 11 needs parameters, the parameters are read from the DMEM 16 by the CP 10 and transferred to the requesting PE 11.

For instance, this sequence is disclosed in Non-patent Literature 1.

However, if the request packets are interchanged every time data is requested by the PEs 11, the bus traffic may significantly increase.

If the 16 PEs request data at the same instant or continuously, the traffic on the ring buses may significantly increase.

Further, it takes time for the PEs 11 to receive the data after requesting it, and thus the PEs 11 must wait until the time when the necessary data is taken before the processing is started.

Therefore, high parallel processing efficiency cannot be expected.

The case where data is preloaded (the case of above-mentioned (2)) is described with reference to FIG. 16.

FIG. 16 shows an initial setting of parameters inside the internal memories (IMEMs) 17 for parallel use in the PEs 11.

Prior to the use of parameters by each PE 11, the whole parameters are read once from the DMEM 16 by the CP 10.

The parameters are then broadcasted to all of the PEs 11 to store the parameters in the IMEM 17 of each PE 11.

During program execution, each PE 11 can access its own IMEM 17 at any timing to read the required parameters.

However, since each PE has all parameters stored in its own IMEM 17, each IMEM 17 requires a very large memory capacity.

Given this situation, a system requires a very large space.

Moreover, preloading takes considerable time to transfer and write a lot of data.

Further, in SIMD architectures, the PEs 11 can be grouped to optimize the usage of the IMEMs 17.

FIG. 17 shows this system structure.

Parameters are distributed to the plurality of IMEMs 17 and stored in the plurality of IMEMs 17.

In this situation, there is a case where a PE wants to access parameters which are not stored in its own IMEM 17 but in a neighboring IMEM 17.

The mechanism as described in Patent Literature 2 can be applied to the SIMD architectures mentioned above.

Here, a number of PEs are grouped together at compile time and have a common internal memory to which they all can make access.

An access indicator is set to all of the PEs which attempt to access the internal memory simultaneously.

One of the PEs with the access indicator is chosen and PEs that attempt to access the same address are sought.

Then, the parameters are loaded from the internal memory and transferred to all the PEs which attempt to access the same address, and the access indicators of these PEs are cleared.

This is repeated till the access indicators from all the PEs are cleared.

By following this way, an optimized access can be reached, because multiple accesses to the same address can be prevented.

A different approach to optimize internal memory accesses and therefore the performance in SIMD architectures by grouping neighboring processing elements together is shown in Patent Literature 3, where two neighboring processing elements are grouped at compile time to paired processor elements.

In these paired processor elements, the same addresses are assigned to elements of both memories which are connected to different data buses.

This allows using, for example, one memory for acquiring data and the other memory for outputting data.

Patent Literature 4 and Patent Literature 5 disclose still another approach.

In Patent Literatures 4 and 5, the assignment is performed by the central processor itself.

In Patent Literature 5, a ring bus controller is provided to control the data shift on a ring bus.

After data are transferred to the ring bus, the central processer directs the ring bus controller to shift data on the ring bus.

With a control action by the ring bus controller, data move on the ring bus by a predetermined amount.

When the predetermined shift action is completed, the ring bus controller informs the central processer that the directed shift action has been completed.

Then, the central processer directs a processer element (PE) to take the data.

The processer element (PE) takes the necessary data.

### CITATION LIST

### Patent Literature

PTL 1: U.S. Pat. No. 3,537,074

PTL 2: U.S. Pat. No. 7,363,472

PTL 3: U.S. Pat. No. 6,785,800

PTL 4: U.S. Pat. No. 5,828,894

PTL 5: EP0147857A2 (Japanese Unexamined Patent Application Publication No. 60-140456)

### Non Patent Literature

NPL 1: Zvonko G. Vranesic, Michael Stumm, David M. Lewis, and Ron White, “Hector: A Hierarchically Structured Shared-Memory Multiprocessor,” Computer, vol. 24, No. 1, pp. 72-79, January 1991, on page 75, lines 1-6

### SUMMARY OF INVENTION

### Technical Problem

The first method to transfer the data (that is, Transfer on request) has the problem that the access is very slow.

One reason is that data has to be transferred for each request again from the DMEM to the IMEM.

Another reason is that while transferring data to one IMEM, all the other PEs are interrupted in their execution to wait till the data request is fulfilled.

The second method to transfer the data (that is, Preloading) is fast but requires a large memory space inside the internal memories, because the parameters data have to be stored inside the IMEM of each PE.

The method disclosed in Patent Literature 2 is targeting this problem of increased internal memory by storing the data in internal memories of a PE group.

It shows further a general way to access the data.

However, for this general way, addresses have to be exchanged between the PEs and compared prior to the memory access, which consumes extra control logic as well as extra processing time for inter PE address transfer and comparison.

The method disclosed in Patent Literature 3 has the disadvantage that the amount of data inside the internal memories cannot be reduced.

The method disclosed in Patent Document 4 has the disadvantage that extra control logic is needed to perform the self grouping.

The method disclosed in Patent Document 5 has the disadvantage that extra control logic is needed to control ring bus shifting and the central processer must manage an output/input action of data by PEs as well as the ring bus shift by the ring bus controller.

The methods described in the above-mentioned Patent/Non Patent literatures are either time or area inefficient.

### Solution to Problem

The present invention has been made in view of the above-mentioned problems, and an object of the present invention is to provide a data processing apparatus, a data processing system, and a data processing method that are capable of transferring and capturing read-only parameters efficiently via ring bus(es) when the read-only parameters are stored in a distributed way over a plurality of internal memories.

### Advantageous Effects of Invention

According to the present invention, it is possible to provide a data processing apparatus, a data processing system, and a data processing method that are capable of effectively reading data when the data is stored in a distributed way over a plurality of internal memories.

### BRIEF DESCRIPTION OF DRAWINGS

The above and other objects, advantages and features of the present invention will be more apparent from the following description of certain exemplary embodiments taken in conjunction with the accompanying drawings, in which:

FIG. 1 is a conceptual block diagram showing an architecture of a data processing apparatus 900 according to an exemplary embodiment of the present invention;

FIG. 2 shows the relationship between the read-only parameters and addresses stored in the DMEM 106;

FIG. 3 shows a form of a global address 600 of each read-only parameter;

FIG. 4 shows the relationship between the Addr_{DMEM} and Addr_{IMEM};

FIG. 5 is a block diagram schematically showing the structure of the PE 101;

FIG. 6 shows the conceptual diagram of the splitting process performed by the splitting unit 122;

FIG. 7 is a block diagram illustrating the splitting unit 122;

FIG. 8 shows a possible software emulation with required clock cycles of the splitting unit;

FIG. 9 is a block diagram illustrating the cmpmv unit 123;

FIG. 10 shows a possible software emulation with required clock cycles of the comparing/moving unit;

FIG. 11 is a flowchart showing a method of processing data in each PE 101;

FIG. 12 shows the processing operation performed in the CP 100 to control a shifting of the ring buses;

FIG. 13 is a block diagram showing a decoding loop of an H.264 video decoder;

FIG. 14 is a diagram illustrating the macro block;

FIG. 15 is a conceptual block diagram illustrating the SIMD architecture in Patent Literature 1;

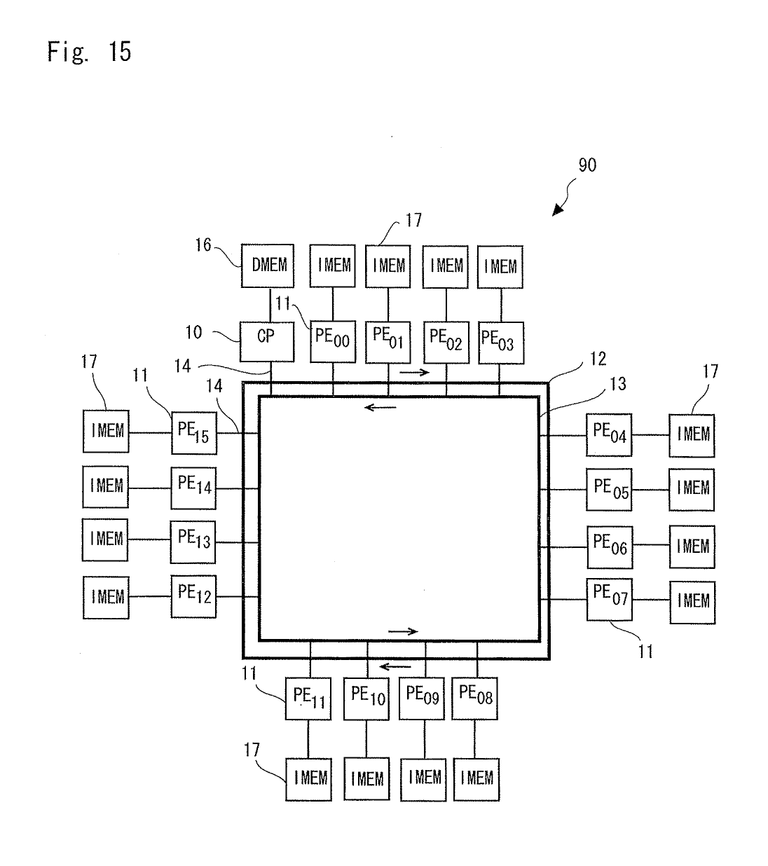

FIG. 16 shows an initial setting of parameters inside the internal memories (IMEMs);

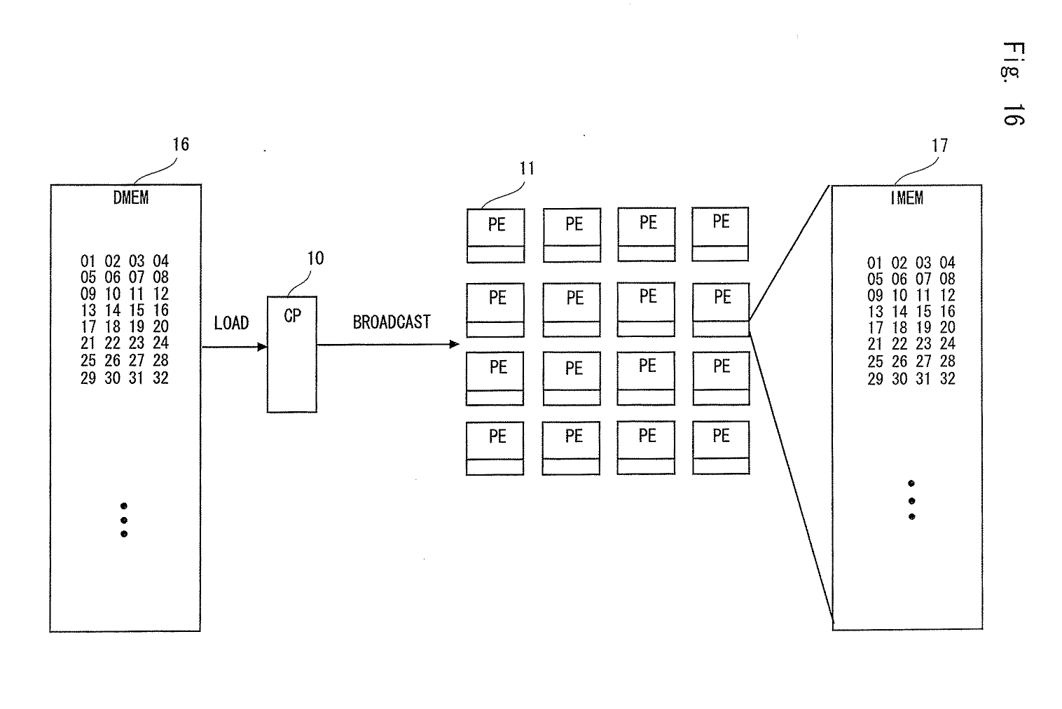

FIG. 17 shows a system structure where the PEs can be grouped to optimize the usage of the IMEMs.

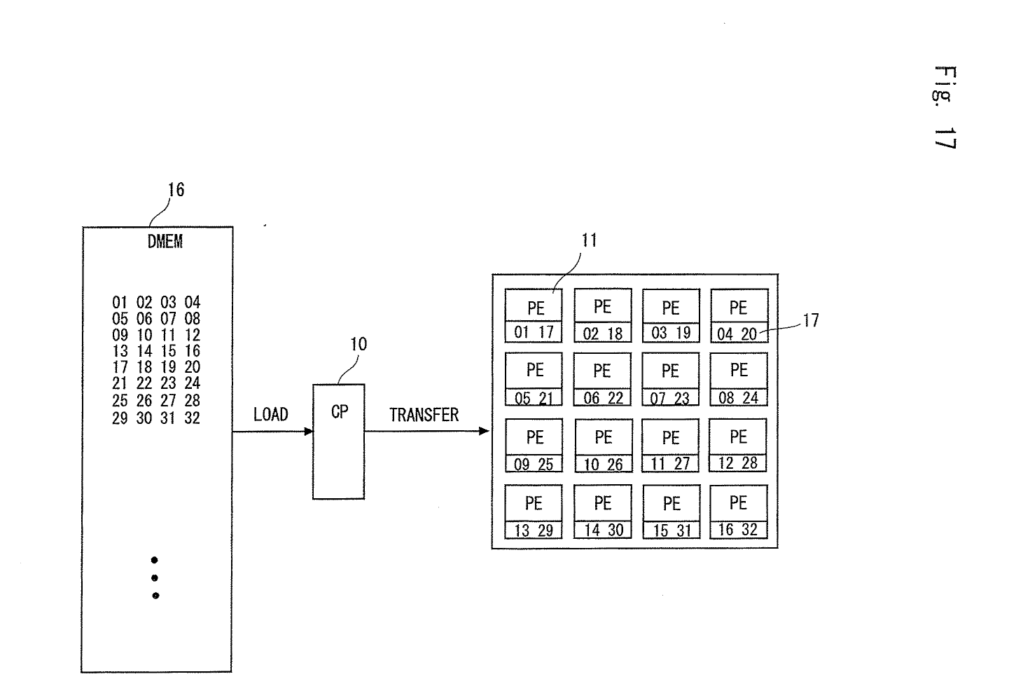

### DESCRIPTION OF EMBODIMENTS

### First Exemplary Embodiment

The data processing apparatus according to an exemplary embodiment of the present invention is a processor that performs in a single instruction multiple data processing (SIMD).

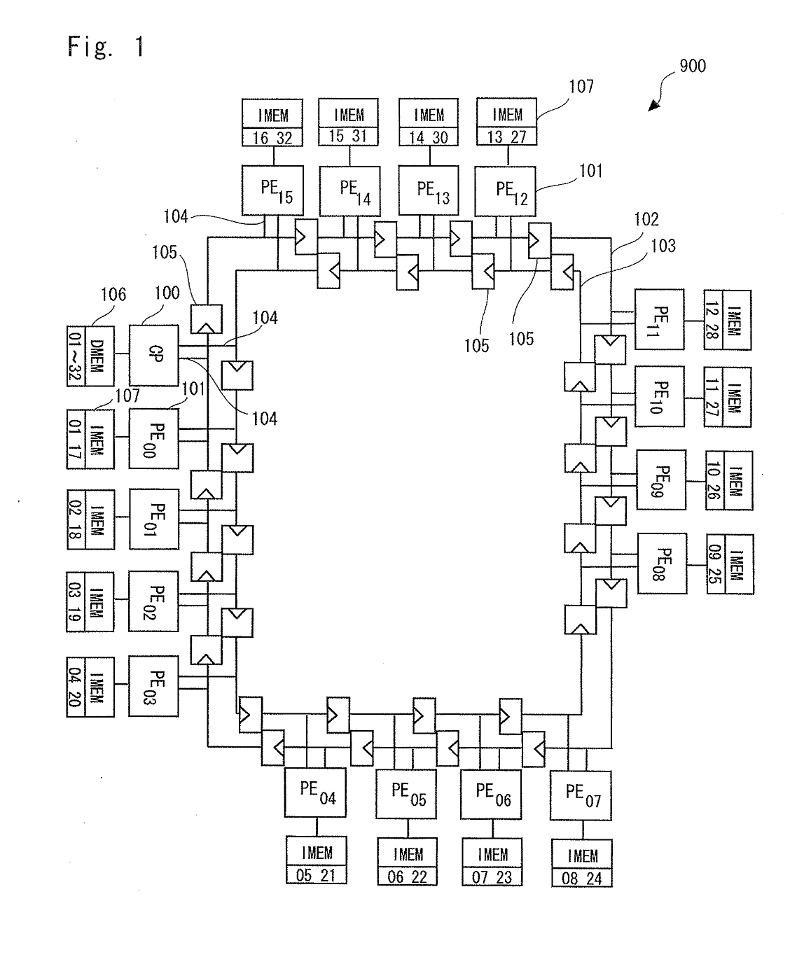

The data processing apparatus according to an exemplary embodiment of the present invention is described with reference to FIG. 1.

FIG. 1 is a conceptual block diagram showing an architecture of a data processing apparatus 900 according to an exemplary embodiment of the present invention.

As shown in FIG. 1, the architecture includes a central processor (CP) 100, a data memory (DMEM) 106, processor elements (PEs) 101, internal memories (IMEMs) 107, a ring bus 102, a ring bus 103, connections 104, and shift registers 105.

The CP 100 has a data memory DMEM 106 which stores read-only parameters, and the PEs 101 use the read-only parameters for processing.

Here, a description is given of a specific example in which 32 read-only parameters are used for processing.

Accordingly, 32 read-only parameters are stored in the DMEM 106.

It is assumed herein that the addresses of 32 read-only parameters stored in the DMEM 106 are respectively set as “00” to “31”.

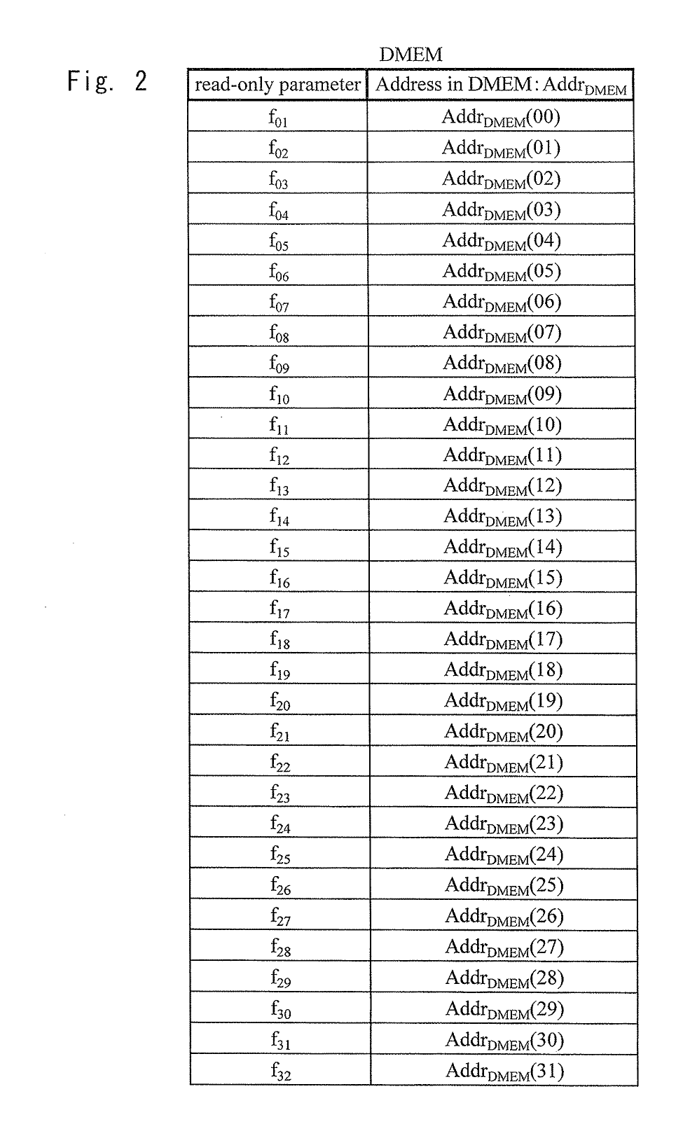

FIG. 2 shows the relationship between the read-only parameters and their addresses Addr_{DMEM} in the DMEM 106.

The CP 100 is connected to the two ring buses 102 and 103 through the connections 104.

The CP 100 reads the read-only parameters stored in the DMEM 106 and the read-only parameters are transferred through the ring buses 102 and 103.

FIG. 1 shows an example in which 16 PEs 101 are provided.

In FIG. 1, subscripts “00” to “15” are added to the 16 PEs 101, respectively, for simplification of the explanation.

In other words, the 16 PEs 101 are respectively identified as PE₀₀ to PE₁₅.

The 16 PEs 101 operate in a SIMD mode; in other words, when the CP 100 sends a single command, the PEs 101 perform parallel processing.

All the PEs 101 are connected to the two ring buses 102 and 103 through the connections 104.

The ring bus 102 and the ring bus 103 are provided with the shift registers 105.

The shift registers 105 are connected to each other on the ring bus 102 and the ring bus 103.

The number of the shift registers 105 on each of the ring buses 102 and 103 corresponds to the number of the PEs 101.

The ring bus 103 transfers data in a direction opposite to that of the ring bus 102; the ring bus 102 transfers data in clockwise direction and the ring bus 103 transfers data in anticlockwise direction.

Therefore, the shift direction of the shift registers 105 on the ring bus 102 is opposite to that of the shift registers 105 on the ring bus 103.

Further, each PE 101 is connected to its own IMEM 107.

Each IMEM 107 serves as a local data storing unit.

A single PE 101 is connected to a single IMEM 107; therefore 16 IMEMs 107 are equal in number to the PEs 101.

These IMEMs 107 store the read-only parameters necessary for parallel processing in a distributed way.

Here, a description is given of a specific example in which each IMEM 107 stores two read-only parameters.

That is, a description is given of an example in which there exist 32 (16×2) read-only parameters in total.

First, the 32 parameters are sequentially transferred by the shift registers 105 provided in the ring bus 102.

The read-only parameter “01” stored at the address “00” is read from the DMEM 106 in a first clock cycle and held in the shift register 105 provided in the ring bus 102.

Note that the CP 100 transfers the data, which is read from the DMEM 106, to the nearest shift register 105.

That is, the read-only parameter “01” is stored in the shift register 105 positioned immediately downstream of the CP 100.

In a subsequent clock cycle, the read-only parameter “01” is transferred to the next shift register 105, and the read-only parameter “02” stored at the address “01” is read from the CP 100 and held in the shift register 105.

By repeating the processing, 16 read-only parameters are held in the shift registers 105.

That is, each shift register 105 provided in the ring bus 102 holds one read-only parameter.

Further, each IMEM 107 stores the read-only parameter data held in the corresponding shift register 105.

Thus, one read-only parameter is held in each IMEM 107.

For example, the read-only parameter “01” is stored in the IMEM 107 of the PE₀₀.

Likewise, the read-only parameters “02” to “16” are stored in the IMEMs 107 of the PE₀₁ to PE₁₅, respectively.

This processing is repeated twice, thereby storing two read-only parameters in each IMEM 107.

The read-only parameters “17” to “32” are transferred in the manner as described above.

As a result, the read-only parameters “01” and “17” are sequentially stored in the IMEM 107 of the PE₀₀, for example.

Next, a description about a global address of each read-only parameter is given.

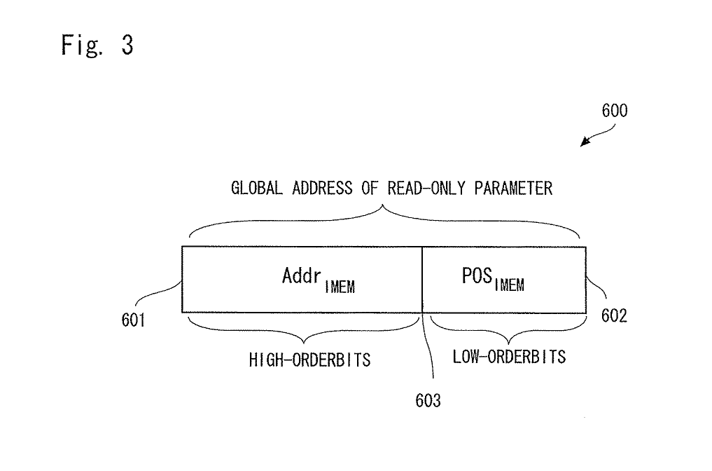

FIG. 3 shows a form of a global address 600 of each read-only parameter.

As shown in FIG. 3, the global address is split into two parts.

High-order bits 601 serve as a part representing an address Addr_{IMEM}, which indicates-the address of the read-only parameter within the IMEM 107.

The address Addr_{IMEM} can be calculated by the following formula.

Addr_{IMEM}=Addr_{DMEM}/PE_PER_GROUP (1)

Since the read-only parameters are stored in a distributed way over the PE group, the Addr_{IMEM} within the IMEM 107 is calculated by dividing the Addr_{DMEM} of the DMEM 106 by the number of the PEs 101.

When attention is focusing on the high-order bits of the Addr_{DMEM}, the Addr_{IMEM} can be calculated. For example, assuming that the Addr_{DMEM} is “27” and PE_PER_GROUP is “16”, Addr_{IMEM} is 1.

When the PE_PER_GROUP is “16” and the Addr_{DMEM} is in the range from “00” to “15”, the Addr_{IMEM} is 0.

When the Addr_{DMEM} is in the range from “16” to “31”, the Addr_{IMEM} is 1.

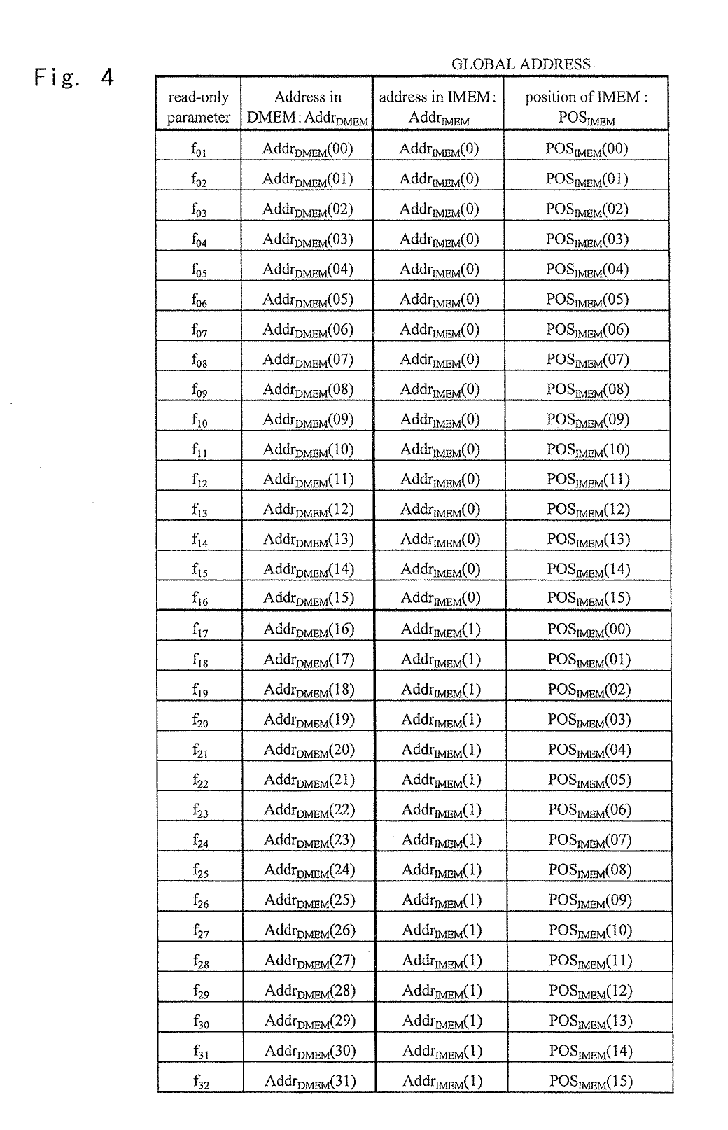

FIG. 4 shows the relationship between the Addr_{DMEM} and Addr_{IMEM}.

In this manner, the address Addr_{DMEM} is divided by the number PE_PER_GROUP of the PEs 101 to calculate the address Addr_{IMEM} within the IMEM 107.

Although a description has been made assuming that PE_PER_GROUP=16 in the above example, the PE_PER_GROUP may be a value other than 16, as a matter of course.

Low-order bits 602 serve as a part representing a POS_{IMEM}, which indicates the position of the IMEM storing the read-only parameter on the ring bus 102.

In other words, the POS_{IMEM} is a portion of the global address of the read-only parameters to be accessed, and the POS_{IMEM} designates the position in the ring bus 102 where the read-only parameter to be accessed is stored.

The POS_{IMEM} is calculated by performing a modulo operation using the Addr_{DMEM} and PE_PER_GROUP (=16 in this example), that is, the remainder of division.

FIG. 4 shows the relationship between the Addr_{DMEM} and POS_{IMEM}.

Thus, the global addresses of read-only parameters are each formed of the two parts 601 and 602.

Note that the part 601 serves as a first operand and the part 602 serves as a second operand.

The part 601 is a higher part of the address standing on the left side of the bit position.

The part 602 is a lower side of the address standing on the right side of the bit position.

A boundary 603 between the low-order part 602 and the high-order part 601 is determined depending on the number of the PEs.

Note that the boundary 603 splitting the address into the two parts varies depending on the number PE_PER_GROUP of the PEs contained in the PE group.

Specifically, the split position is calculated by log₂ (PE_PER_GROUP).

For example, when the number of the PEs is 16 (=2⁴), a bit position at which the global address is split (split position) corresponds to a low-order fourth bit.

Accordingly, the boundary 603 is located between the low-order fourth bit and a low-order fifth bit.

The low-order four bits represent the POS_{IMEM}, and the higher bits represent the Addr_{IMEM}.

Assuming that the Addr_{DMEM} is represented by 16 bits, for example, the high-order 12 bits correspond to the Addr_{IMEM}.

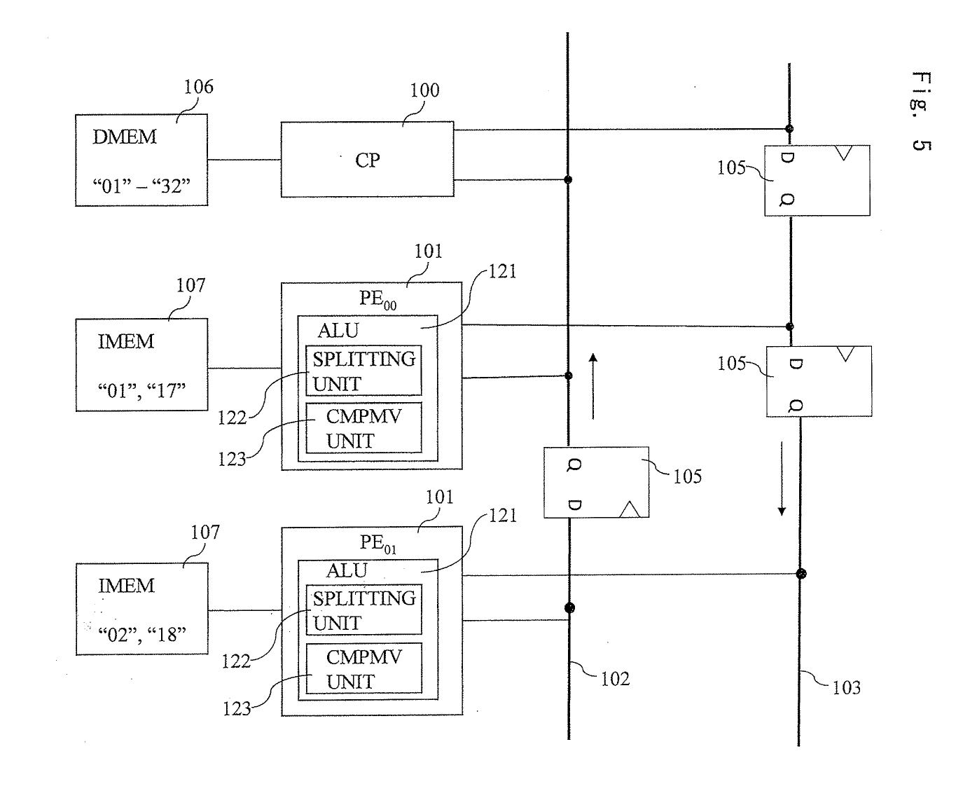

Next, the structure of the PE 101 is described with reference to FIG. 5.

FIG. 5 is a block diagram schematically showing the structure of the PE 101.

As shown in FIG. 5, the PE 101 includes an arithmetic unit (ALU) 121 that performs various operations.

The arithmetic unit 121 is provided with a splitting unit 122 and a comparing/moving unit 123.

The splitting unit 122 performs split processing for splitting the Addr_{DMEM} into two parts.

The comparing/moving (cmpmv) unit 123 performs comparing/moving processing for comparing a shift distance “shift” with the number of shifts on the ring buses 102 and 103 to move the read-only parameters.

Further, the processings performed in the PE 101 are described in detail.

First, a description is given of the processing for splitting the Addr_{DMEM} into two parts (hereinafter, referred to also as “split processing”) among the processings performed in the PE 101.

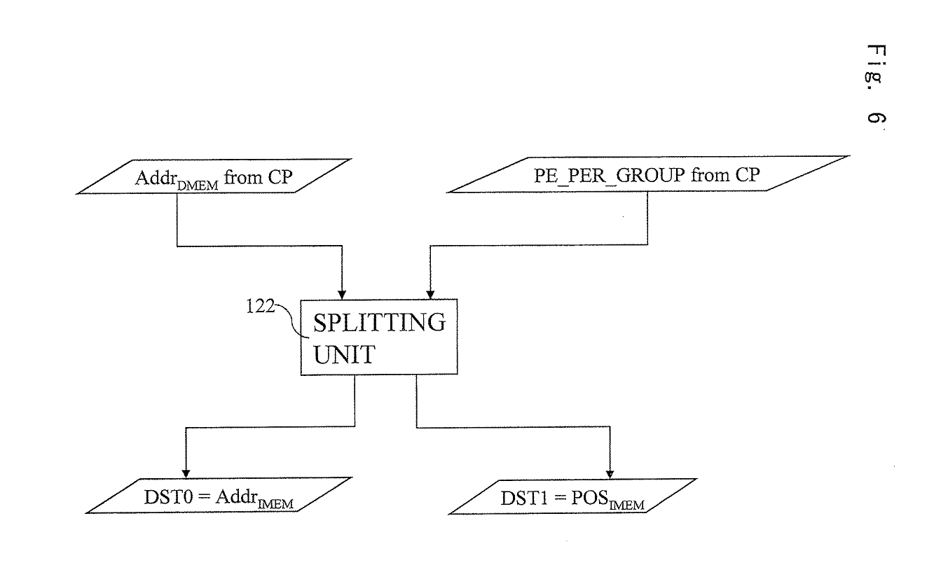

FIG. 6 shows the conceptual diagram of the splitting process performed by the splitting unit 122.

The split processing is performed based on the Addr_{DMEM} and PE_PER_GROUP.

The Addr_{DMEM} and PE_PER_GROUP are input from the CP 100 to each splitting unit 122.

Then, each splitting unit 122 splits the Addr_{DMEM} using log₂ (PE_PER_GROUP).

Note that the log₂ (PE_PER_GROUP) is given by a natural number.

It is assumed herein that values obtained by splitting the Addr_{DMEM} into two parts are represented as DST0 and DST1, respectively.

Specifically, the Addr_{DMEM} is split at a splitting point determined depending on the number of the PEs, thereby obtaining the two outputs DST0 and DST1.

Here, the DST0 corresponds to the Addr_{IMEM}, and the DST1 corresponds to the POS_{IMEM}.

These values can be calculated by the following formula (2).

(DST0, DST1)=split (Addr_{DMEM}, log₂(PE_PER_GROUP)) (2)

For example, when the PE_PER_GROUP is the n-th power of 2 (n is a natural number), the log₂ (PE_PER_GROUP) is a natural number.

In this example, the DST0 is equal to (Addr_{DMEM}/PE_PER_GROUP) and corresponds to the Addr_{IMEM} expressed by the formula (1).

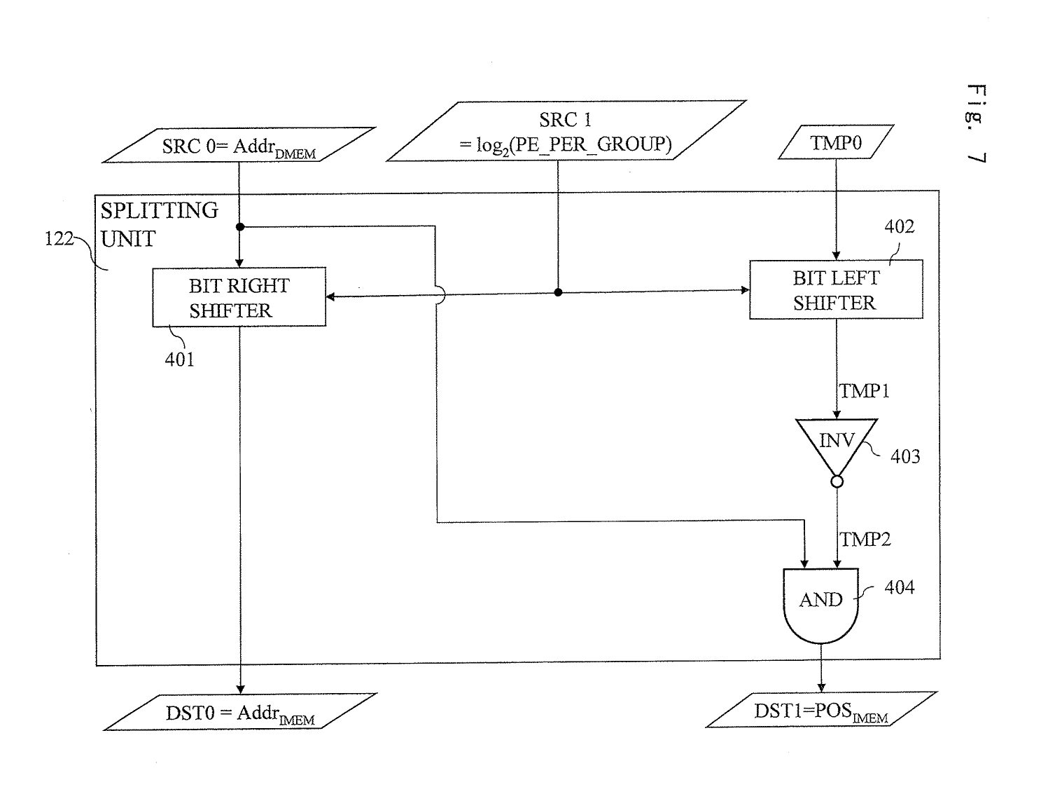

Next, the structure of the splitting unit is described with reference to FIG. 7.

FIG. 7 is a block diagram illustrating the splitting unit 122 in each PE 101.

Each PE 101 splits the input value (Addr_{DMEM}) into two parts.

Here, a description is given assuming that the Addr_{DMEM} is represented by 16 bits.

In FIG. 7, SRC0 and SRC1 are transferred from the CP 100.

The SRC0 corresponds to 16-bit Addr_{DMEM}, and the SRC1 is a value of a bit shift amount indicating PE_PER_GROUP.

Note that the SRC0 is an unsigned value.

Here, the number of the PEs contained in the PE group is 16 (=2⁴), and thus the bit shift amount is 4.

That is, the number of bits indicating the number of PEs corresponds to the bit shift amount.

A bit right shifter 401 shifts the bits of the SRC0 rightward by the bit shift amount.

Thus, the SRC0 is shifted rightward by four bits.

As a result, attention is focused on high-order 12 bits of the Addr_{DMEM}.

Then, the value obtained by shifting the bits of the SRC0 rightward is output as the DST0.

The DST0 corresponds to the Addr_{IMEM}.

The DST0 is calculated based on the SRC0 and SRC1 in the manner as described above.

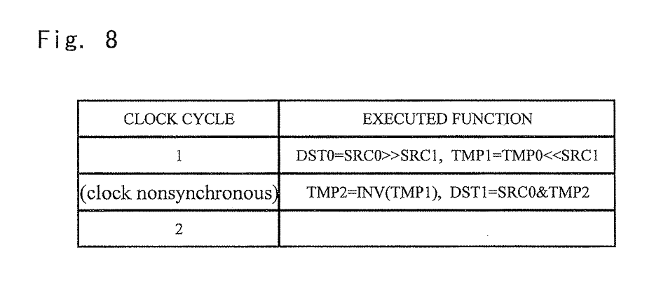

That is, a value obtained by shifting rightward the SRC0 by the number of bits (number of digits) corresponding to the SRC1 corresponds to the DST0 (refer to FIG. 8).

For example, when the SRC0 (binary notation) indicates “1101101101001101”, the high-order 12 bits “110110110100” represent the DST0.

Accordingly, the DST0 corresponds to the Addr_{DMEM}.

Here, in FIG. 7, all the values of 16 bits of TMP0 are 1.

Specifically, the TMP0 is fixed by a maximum value represented by the number of bits equal to that of the Addr_{DMEM}.

The TMP0 is represented as “1111111111111111” in binary notation.

A bit left shifter 402 shifts the bits of the TMP0 leftward by the SRC1.

Specifically, the bit left shifter 402 replaces low-order four bits of the TMP0 with a value of 0.

As a result, the output TMP1 of the bit left shifter 402 is represented as “1111111111110000”.

That is, a value obtained by shifting leftward the TMP0 by the number of bits (number of digits) corresponding to the SRC1 corresponds to the TMP1 (refer to FIG. 8).

An inverter 403 inverts the values of the bits of the TMP1.

The TMP1 is subjected to inversion processing and output as TMP2 (refer to FIG. 8).

As a result, the output TMP2 of the inverter 403 is represented as “0000000000001111”.

That is, the values of the low-order four bits are 1, and the values of the high-order 12 bits are 0.

Then, an AND block 404 calculates a logical AND between the SRC0 and the TMP2.

The AND between the SRC0 and the TMP2 is output as the DST1 (refer to FIG. 8).

At this time, in the TMP2, only the values of low-order four bits are 1 and the values of high-order 12 bits are 0.

Accordingly, the AND block 404 focuses attention on low-order four bits of the SRC0.

In other words, the output DST1 of the AND block 404 is equal to the values of the low-order four bits of the SRC0.

The DST1 corresponds to the POS_{IMEM}.

In this manner, the Addr_{DMEM} can be split into two parts.

Further, the shift distance “shift” can be obtained using the values.

Each PE 101 calculates the shift distance “shift”.

The shift distance “shift” defines the number of shifts on the ring buses.

The shift distance “shift” is an integer representing a shift distance between the positions POS_{own} and POS_{IMEM}.

Here, it is assumed that a PE 101 requesting a read-only parameter, that is, the PE 101 serving as an access destination is the own PE, and the position thereof is represented as POS_{own}.

And, the position of the IMEM 107 holding the read-only parameter, that is, the position of the IMEM which is an access source is represented as POS_{IMEM}.

In other words, the position of the PE 101 requesting the necessary read-only parameter is represented as POS_{own}, and the position of the IMEM 107 storing the necessary read-only parameter is represented as POS_{IMEM}.

Note that, since the positions POS_{own} and POS_{IMEM} are located on the ring bus 102, the positions are represented by natural numbers, for example, “00” to “15” as shown in FIG. 1.

For example, suffixes added to the PEs as shown in FIG. 1 represent the positions.

The POS_{own} is calculated by performing the modulo operation using the own PE number PE_{own} and PE_PER_GROUP.

Here, the modulo operation using the PE_PER_GROUP is necessary for the general case.

The modulo operation is necessary when, for example, the number NO_OF_PE of available PEs inside the architecture is not equal to the number PE_PER_GROUP of the PEs 101 in a group.

If these numbers are equal, the modulo operation for calculating the POS_{own} can be eliminated.

That is, the PE_{own} is equal to the POS_{own}.

The shift distance “shift” corresponds to the number of times of data transfer until the read-only parameter reaches the POS_{own} on the ring bus 102 or ring bus 103.

Accordingly, the shift distance “shift” can be calculated by subtracting the POS_{IMEM} from the POS_{own}.

The shift distance “shift” is a signed integer corresponding to the number of times of data transfer (the read-only parameter) until the data reaches the POS_{own} from the POS_{IMEM}.

For example, when POS_{own}=4 and POS_{IMEM}=6, the shift distance “shift” is −2.

Further, when POS_{own}=6 and POS_{IMEM}=3, the shift distance “shift” is +3.

The shift distances “shift” are calculated in parallel in the PEs 101.

Here, the Addr_{DMEM} and PE_PER_GROUP are sent from the CP 100 to each PE 101.

Further, each PE 101 holds the POS_{own} in advance.

Each shift distance “shift” is calculated by the following formula.

“shift”=POS_{own}−POS_{IMEM}=(PE_{own} % (PE_PER_GROUP))−(Addr_{DMEM} % (PE_PER_GROUP)) (3)

where, “%” means modulo operation.

As expressed by the above formula (3), the shift distance “shift” is calculated based on the difference between the POS_{own} and the POS_{IMEM}.

The absolute value of the shift distance “shift” defines the number of shifts necessary for acquiring the data, and the sign of the shift distance “shift” defines the shift direction.

That is, depending on whether the sign of the shift distance “shift” is positive or negative, it is determined that the data (the read-only parameter) is acquired from which one of the ring buses 102 and 103.

For example, when the sign of the shift distance “shift” is positive, the data is acquired from the ring bus 102, and when the sign is negative, the data is acquired from the ring bus 103.

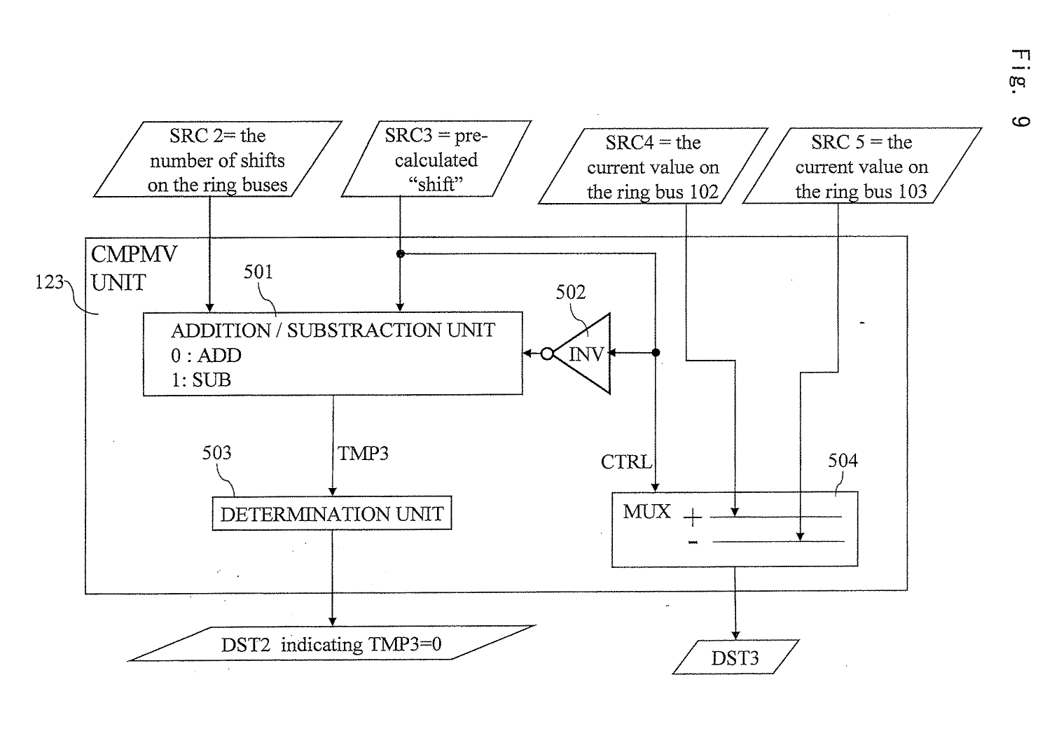

Next, the structure of the cmpmv unit 123 is described with reference to FIG. 9.

FIG. 9 is a block diagram illustrating the structure of the cmpmv unit 123 in each PE 101.

The cmpmv unit 123 performs processing of comparing the input values and transfer processing according to a comparison result.

The number of shifts on the ring buses 102 and 103 is input as SRC2.

The SRC2 is an unsigned value, that is, a positive value.

Further, the pre-calculated shift distance “shift” is input as SRC3.

Note that the shift distance “shift” is a signed value.

In other words, the most significant bit (MSB) of the shift distance “shift” represents a sign.

For example, when the most significant bit of the shift distance “shift” is 1, the shift distance “shift” is negative, and when the most significant bit is 0, the shift distance “shift” is positive.

Thus, the most significant bit of the shift distance “shift” is a sign bit representing the sign.

Note that the shift distance “shift” is calculated by each PE 101 according to the formula (3).

An addition/subtraction unit 501 performs an addition/subtraction of the unsigned SRC2 with the signed SRC3.

For this processing, the sign bit of the SRC3 is input to an inverter 502.

The inverter 502 inverts the sign bit of the SRC3.

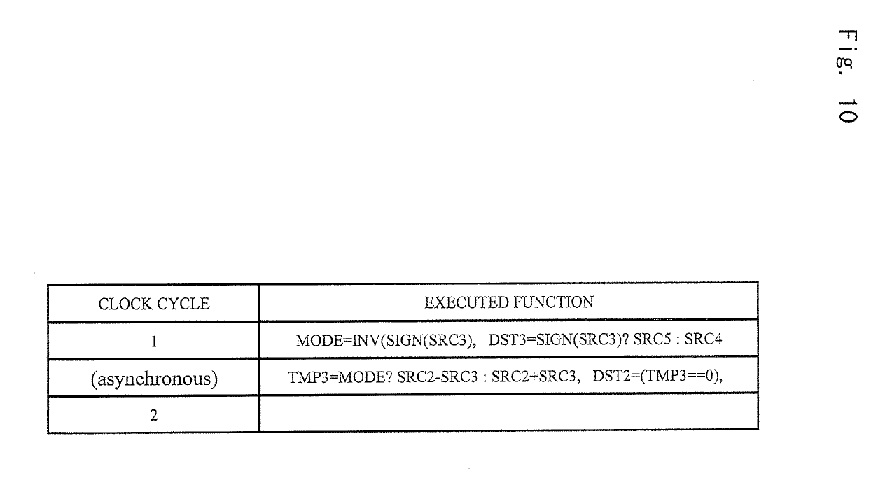

The sign bit of the SRC3 is inverted and a mode signal “mode” is output (refer to FIG. 10).

The inverted bit serves as the mode signal “mode” for determining the mode of the addition/subtraction unit.

The inverter 502 outputs the inverted bit as the mode signal “mode” to the addition/subtraction unit 501.

As described above, when the shift distance “shift” is negative, the value of the sign bit is 1.

In this case, the inverter 502 sets the value of the inverted bit to 0.

When the value of the inverted bit is 0, the addition/subtraction unit 501 shifts to an addition mode.

Thus, the addition/subtraction unit 501 calculates a sum of the SRC2 and the SRC3.

On the other hand, when the shift distance “shift” is positive, the value of the sign bit is 0.

In this case, the inverter 502 sets the value of the inverted bit to 1.

Then, the inverter 502 outputs the inverted bit to the addition/subtraction unit 501.

When the value of the inverted bit is 1, the addition/subtraction unit 501 shifts to a subtraction mode, and thus calculates a difference between the SRC2 and the SRC3.

Thus, addition or subtraction is performed, and TMP3 is output (refer to FIG. 10).

As described above, the inverter 502 serves the addition/subtraction unit 501 that switches the mode.

Specifically, the inverter 502 receives the sign bit of the shift distance “shift”.

Then, the addition/subtraction unit 501 performs switching between the addition mode and the subtraction mode in accordance with the sign of the shift distance “shift”, that is, the most significant bit MSB.

Further, the addition/subtraction unit 501 executes the addition mode and the subtraction mode while switching the modes in accordance with the output of the inverter 502.

That is, the addition/subtraction unit 501 performs addition or subtraction exclusively.

Accordingly, the addition/subtraction unit 501 outputs the sum or difference between the SRC2 and the SRC3 as the TMP3.

The sum or difference between the SRC2 and the SRC3 is input as the TMP3 to a determination unit 503.

The determination unit 503 determines whether the TMP3 is 0 or not.

When the absolute values of the SRC2 and SRC3 are equal to each other, the TMP3 is 0.

Specifically, when all the bit values of the TMP3 are 0, the TMP3 is 0.

Further, when the TMP3 is 0, the determination unit 503 outputs a signal DST2 indicating that the TMP3 is 0.

For example, when TMP3=0, DST2=1, and when the TMP3 is a value other than 0, DST2=0.

Thus, it is determined whether the TMP3 is 0 or not and the DST2 is output (refer to FIG. 10).

In this manner, the signal DST2 indicating whether the TMP3 is 0 or not is output from the determination unit 503.

The PE 101 acquires the data of the read-only parameter from the ring bus 102 or 103 in response to the DST2=1.

Thus, the timing for acquiring the read-only parameter is determined.

Next, a description is given of processing for determining from which one of the ring buses 102 and 103 the PE 101 should acquire the read-only parameter.

For this processing, SRC4 and SRC5 are input to a multiplexer 504.

Further, the multiplexer 504 receives the sign bit of the SRC3 through an input line “ctrl”.

The value of the SRC4 is the current value on the clockwise ring bus 102.

The value of the SRC5 is the current value on the anticlockwise ring bus 103.

When the input line ctrl of the multiplexer 504 is 0, the SRC4 is passed through the multiplexer 504.

Meanwhile, when the input line ctrl of the multiplexer 504 is 1, the SRC5 is passed through the multiplexer 504.

Thus, the multiplexer 504 determines the ring bus from which the PE_{own} should take the read-only parameter, in accordance with the sign bit of the SRC3 (refer to FIG. 10).

For example, when the sign of the SRC3 is positive, the value of the SRC4 is output as DST3.

In this case, the clockwise ring bus 102 is selected.

On the other hand, when the sign of the SRC3 is negative, the value of the SRC5 is output as the DST3.

In this case, the anticlockwise ring bus 103 is selected.

Then, when the DST2 is 1, the PE 101 acquires the read-only parameter from the selected ring bus.

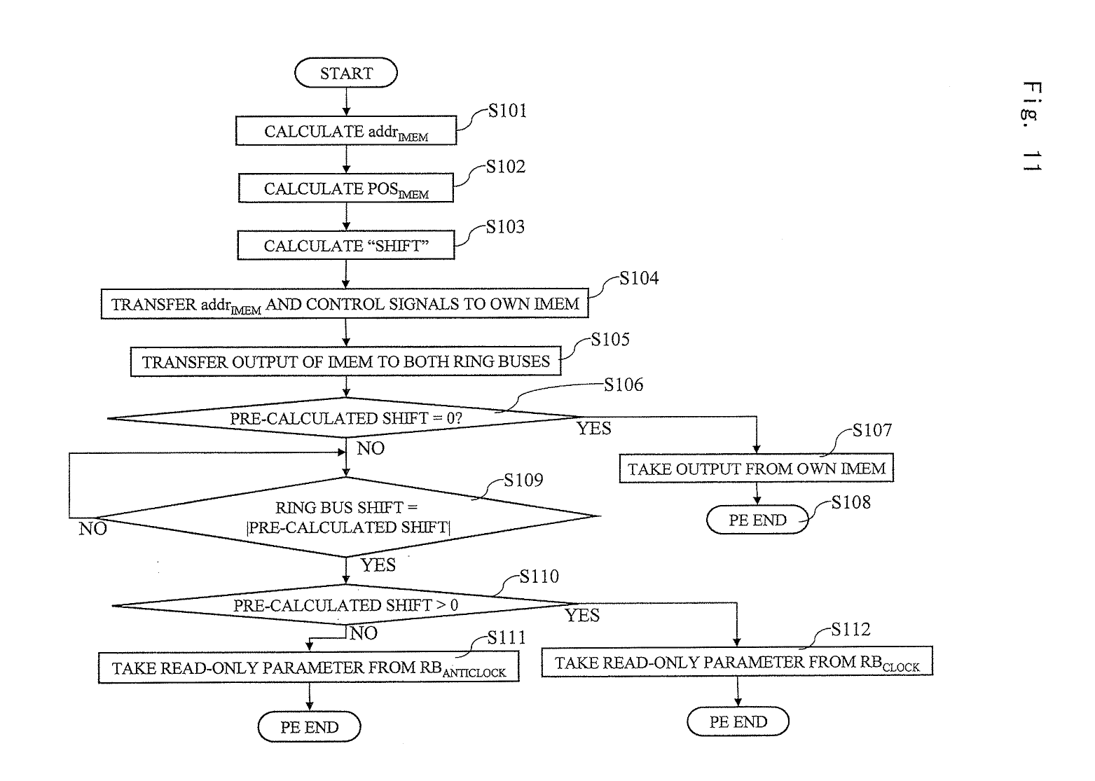

Processing operations executed by the splitting unit 122 and the-cmpmv unit 123 are described in detail with reference to FIG. 11.

Note that a specific example is given herein assuming that all the PEs 101 use one same read-only parameter in parallel processing.

Such a case is generated for image processing using a de-blocking filter.

FIG. 11 is a flowchart showing a method of processing data in each PE 101.

That is, the data processing shown in FIG. 11 is executed in each PE 101.

The address of the read-only parameter necessary for the parallel processing, which is held in the DMEM 106, is transferred from the CP 100 to each PE 101.

For example, when the de-blocking filter processing is performed in the SIMD mode, the Addr_{DMEM} of the read-only parameter necessary for the parallel processing and PE_PER_GROUP are transferred from the CP 100.

Then the splitting unit 122 of each PE 101 calculates the Addr_{IMEM} of the read-only parameter (Step S101).

In other words, each PE 101 obtains the Addr_{IMEM} by the above formula (1) using the Addr_{DMEM} and PE_PER_GROUP.

Next, the position of the IMEM 107, which holds the necessary read-only parameter, on the ring buses 102 and 103 is calculated (Step S102).

Here, each PE 101 calculates the POS_{IMEM}.

As described above, the POS_{IMEM} is calculated by performing the modulo operation using the Addr_{DMEM} and PE_PER_GROUP.

Here, Step S101 and Step S102 are carried out by the splitting unit 122.

The processing including the step of outputting the DST0 shown in FIG. 7 corresponds to the processing of Step S101.

The processing including the step of outputting the DST1 shown in FIG. 7 corresponds to the processing of Step S102.

Next, each PE 101 calculates the shift distance “shift” (Step S103).

“shift”=POS_{own}−POS_{IMEM}=(PE_{own} % (PE_PER_GROUP))−(Addr_{DMEM} % (PE_PER_GROUP)) (3)

Next, each PE 101 transfers the address (Addr_{IMEM}) and control signals to the IMEM 107 (Step S104).

Each PE 101 sends a command for acquiring the read-only parameter corresponding to the Addr_{IMEM} to each IMEM 107.

Then, the output of each IMEM 107 is sent to both the ring buses 102 and 103 (Step S105).

More specifically, the PE 101 receives from the IMEM 107 the read-only parameter stored in the position of the Addr_{IMEM} inside the IMEM 107, and transfers the read-only parameter to the ring buses 102 and 103.

Next, it is determined whether the pre-calculated shift distance “shift” is 0 or not (Step S106).

In other words, each PE 101 determines whether the read-only parameter is stored in its own IMEM 107 or not.

When the pre-calculated shift distance “shift” is 0 (YES in Step S106), the PE 101 takes the output of the own IMEM 107 (Step S107).

More specifically, the PE 101 acquires the read-only parameter stored in the IMEM 107 corresponding to the PE 101.

The read-only parameter may be acquired from the shift register 105 or the IMEM 107, as a matter of course.

Thus, as to the PE 101 with the shift distance “shift” equal to 0, the read-only parameter is acquired before being shifted.

Then, as to the PE 101 with the shift distance “shift” equal to 0, the processing for acquiring the read-only parameter is ended (Step S108).

When the pre-calculated shift distance “shift” is not 0 (NO in Step S106), the read-only parameter is shifted on the ring buses.

Then, the cmpmv unit 123 compares the number of shifts on the ring buses 102 and 103 with the absolute value of the shift distance “shift” (Step S109).

When the number of shifts on the ring buses 102 and 103 is smaller than the absolute value of the shift distance “shift” (NO in Step S109), the read-only parameter is shifted again.

In other words, the read-only parameter is repeatedly shifted until the number of shifts performed on the ring buses 102 and 103 becomes equal to the absolute value of the pre-calculated shift distance “shift”.

Then, when the shift distance “shift” is equal to the number of shifts on the ring buses (YES in Step S109), it is determined whether the shift distance “shift” is greater than 0.

That is, the sign of the shift distance “shift” is determined.

When the sign is negative (NO in Step S110), the data of the read-only parameter is acquired from the anticlockwise ring bus 103 (Step S111).

When the sign is positive (YES in Step S110), the data of the read-only parameter is acquired from the clockwise ring bus 102 (Step S112).

Here, Steps S109 to S112 are carried out by the cmpmv unit 123.

The processing including the step of outputting the DST2 shown in FIG. 9 corresponds to the processing of Step S109.

The processing including the step of outputting the DST3 shown in FIG. 9 corresponds to the processing from Steps S110 to S112.

In the manner as described above, the read-only parameter is transferred through the ring buses 102 and 103.

Further, each PE 101 takes the read-only parameter necessary for processing.

The acquired read-only parameter is stored in a register incorporated in each PE 101.

Then, each PE 101 carries out the processing (e.g., de-blocking filter processing) by using the read-only parameter.

As a matter of course, each PE 101 carries out the processing in the SIMD mode.

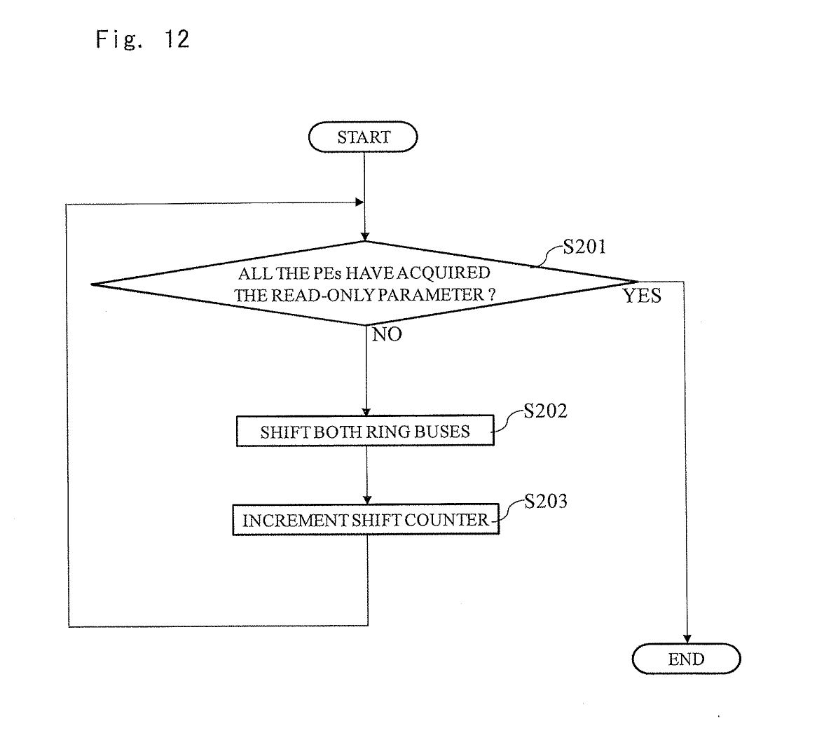

Next, processing operation performed in the CP 100 is described with reference to FIG. 12.

FIG. 12 shows the processing operation performed in the CP 100 to control a shifting of the ring buses.

First, it is determined whether all the PEs 101 have already completed acquisitions of the read-only parameter (Step S201).

In the case where all the PEs 101 have already acquired the read-only parameter (YES in Step S201), the processing performed in the CP 100 is ended.

In the case where not all the PEs 101 have completed acquisitions of the read-only parameter (NO in Step S201), the CP 100 shifts the read-only parameters by 1 on the ring buses 102 and 103 (Step S202).

Additionally, a shift counter for counting the number of shifts is incremented by 1 (Step S203).

Then, returning to Step S201, the same processing is repeated until all the PEs 101 complete the acquisition of the read-only parameter.

Next, the effects of this exemplary embodiment will be described.

(1) When the read-only parameter data is stored in a distributed way in the PE group including 16 PEs as described in Patent Document 2, however unlike Patent Document 2, the read-only parameter data is concurrently read with the same global address by the PEs.

This eliminates the need of requesting transfer of address information between the PEs 101.

In other words, it is not necessary to transfer the read-only parameter position information between the PEs 101.

Because each PE 101 is notified of the correct position information in advance, and thus each PE 101 recognizes which PE 101 holds the necessary read-only parameter.

The Addr_{IMEM} of the read-only parameter is calculated by the PEs, and a distance between the PE 101 requesting the read-only parameter and the PE 101 holding the read-only parameter can be calculated in parallel by the PEs 101 in advance.

As a result, the efficiency of data processing is drastically improved.

(2) Even when the read-only parameter data is stored in a distributed way over the IMEMs 107, a processing time necessary for access can be reduced.

The two ring buses 102 and 103 having opposite transfer directions are connected to the PEs 101, which makes it possible to reduce the processing time to about a half.

That is, a maximum value of the number of shifts can be reduced to a half of the number of the PEs 101.

Accordingly, in the example shown in FIG. 1, the ring buses are shifted eight times at maximum so that all the PEs 101 can acquire the necessary read-only parameter.

(3) In the manner as described above, the arithmetic processing can be performed using the data stored in the other IMEMs 107.

In other words, the read-only parameters necessary for the plurality of PEs 101 to perform the processing can be stored in the other IMEMs 107.

Further, the read-only parameter data of the DMEM 106 can be stored in a distributed way over the plurality of IMEMs 107.

As a result, the amount of the IMEMs 107 can be reduced.

(4) The use of the splitting unit 122 enables split processing in one clock cycle.

Each functional unit of the splitting unit 122 illustrated in FIG. 7 is executed as a single operation in one clock cycle.

Accordingly, this new unit can reduce the number of necessary clock cycles from four to one as shown in FIG. 8.

This clock cycle reduction is achieved because the four functions of the splitting unit 122 are processed in the same clock cycle without involving any buffer or register that delays the intermediate signals.

(5) Each functional unit of the cmpmv unit 123 illustrated in FIG. 9 is executed as a single operation in one clock cycle.

Accordingly, this new unit can reduce the number of necessary clock cycles from four to one as show in FIG. 10.

This clock cycle reduction is achieved because the four functions of cmpmv unit 123 are processed in the same clock cycle without involving any buffer or register that delays the intermediate signals.

### Second Exemplary Embodiment

The data processing apparatus that performs in a single instruction multiple data processing (SIMD) mentioned above can preferably be applied to a parallel image processor.

A description is given herein assuming that the architecture mentioned above is used for an H.264 de-blocking filter.

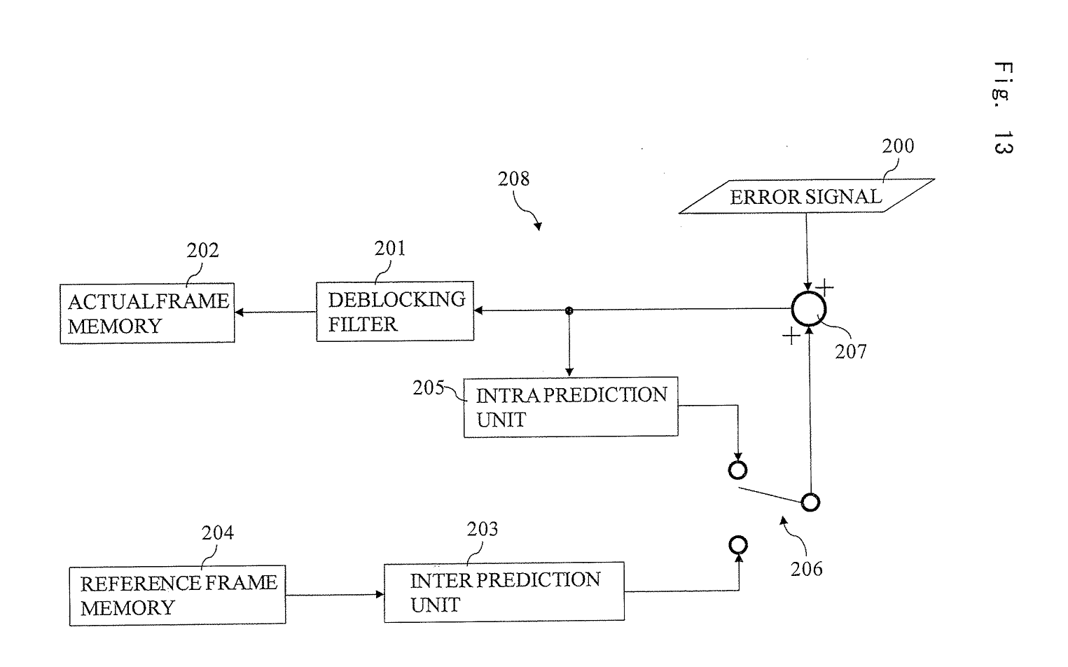

FIG. 13 is a block diagram showing a decoding loop 208 of an H.264 video decoder.

An H.264 de-blocking filter 201 is a closed-loop filter which operates inside the decoding loop 208, together with an inter prediction unit 203 and an intra prediction unit 205.

The de-blocking filter 201 serves as a low-pass filter (LPF).

There are provided an addition unit 207, a selection unit 206, a reference frame memory 204, and an actual frame memory 202.

The addition unit 207 adds an error signal 200 and a reconstructed pixel value of an image decoded in the decoding loop of the H.264 decoder.

To decode an image in a decoder, two techniques, i.e., intra prediction and inter prediction are employed.

In the inter prediction, a pixel value of frames, which have been already decoded, is used to decode an image.

Meanwhile, in the intra prediction, data of already decoded adjacent macro blocks of the actual frame are used to decode the currently processed macro block.

Here, selection between the intra prediction and inter prediction is carried out in an H.264 video encoder.

A signal for selecting one of the intra prediction and inter prediction is transmitted as side information in an H.264 stream to the H.264 decoder, together with the error signal.

The actual frame memory 202 is a frame memory for storing actual frames.

The reference frame memory 204 is a memory for storing reference frames for use in inter prediction.

In the case of coding at high compression ratios, block-wise lossy decoding is alleviated in the de-blocking filter 201.

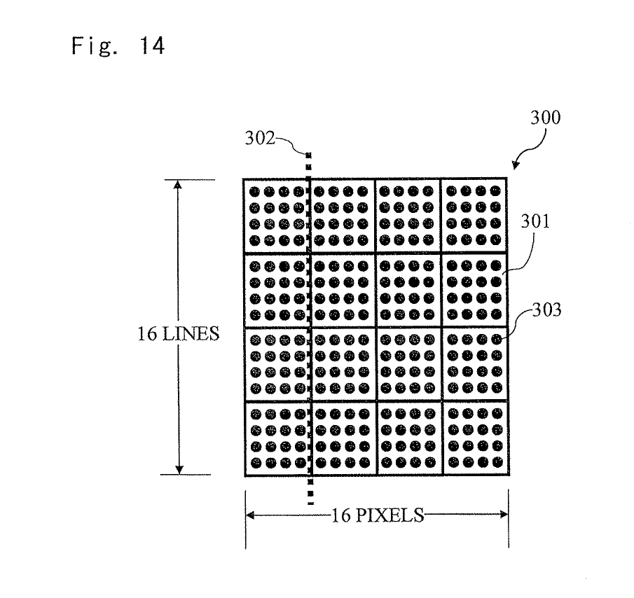

Here, macro blocks in the H.264 de-blocking filter 201 are described with reference to FIG. 14.

FIG. 14 is a diagram illustrating the macro blocks.

But for the de-blocking filter 201, two image pixels 303 in two different macro blocks 300 or sub blocks 301 which describe the same image content result in different decoded values on both sides of a block boundary 302 after the independent prediction and coding of the two pixels.

The de-blocking filter 201 alleviates such a difference between decoded values according to the estimated magnitude of the difference.

Since the difference is caused by quantization, the magnitude of the difference is related to the quantization noise.

Therefore, two parameters “α” and “C0” are introduced.

The parameters “α” and “C0” are proportional to the quantization-step size, and are also proportional to the square root of the noise variance.

Additionally, a third parameter “β” is introduced.

All the parameters determine the allowable impact of the filter on the block edge.

While the parameters “α” and “C0” are related to the magnitude of blocks, the parameter “β” is related to the signal flatness near the block boundary 302 and is therefore related to the visibility.

A description is given of the luminance component of the de-blocking filter.

As shown in FIG. 14, it is assumed that a single macro block 300 includes 16×16 image pixels 303.

Sixteen filter operations are performed on a single edge 302 of the macro block.

Note that FIG. 14 shows a macro block structure for use in de-blocking filter processing for the H.264 video decoder.

Each macro block 300 is further divided into 16 sub blocks 301.

A single sub block 301 includes 4×4 image pixels 303.

Each edge 302 runs between two neighboring sub blocks 301.

To process one edge, a set of 8 image pixels, 4 on each side of edge, are needed.

If these 16 filter operations are mapped onto 16 (NO_OF_PE) PEs 101 of FIG. 1, all the 16 filter operations are executed in parallel in a single PE group (PE_PER_GROUP=NO_OF_PE=16 PEs).

In addition to picture data itself, tables for the read-only parameters (α, β, C0) are necessary for the de-blocking filter processing.

Further, in addition to the picture data and the tables for the read-only parameter data, an address which is equal to an index to the tables is required for each edge.

For example, the read-only parameters α, β, and C0 necessary for the de-blocking filter processing are transferred from the DMEM 106 and stored in a distributed way over all IMEM of the PE group.

When data is decoded using intra prediction, the same read-only parameter may be read by all the PEs 101.

Specifically, in the de-blocking filter processing, the plurality of PEs 101 performs the parallel processing by reading the parameter of the same value.

In this case, the CP 100 sends a command to read the same parameter set.

Then, all the PEs 101 read the parameter of the same value.

The 16 PEs 101 perform the parallel processing by reading the parameter of the same value.

A data processing method in which all the PEs 101 read the parameter of the same value is described above.

While the invention has been particularly shown and described with reference to exemplary embodiments thereof, the invention is not limited to these embodiments.

It will be understood by those of ordinary skill in the art that various changes in form and details may be made therein without departing from the spirit and scope of the present invention as defined by the claims.

Note that the components that perform various processing have been described as unit or block, but it can also be replaced by the unit or block with means.

Although the processor elements employing SIMD technology have been described above by way of example, the present invention can also be applied to other processor elements.

For example, a processor element that performs parallel processing other than the de-blocking filter processing may be used.

As illustrated in FIG. 7, while the SRC0 is shifted rightward and the TMP0 is shifted leftward, the shift directions may be reversed.

For example, when the whole structure of the address Addr_{DMEM}, the address Addr_{IMEM}, and the position POS_{IMEM} are reversed, the shift direction is reversed.

The term “reversed” herein means that the least significant bits are on the left side and the most significant bits are on the right side.

Therefore, in this case, the SRC0 is shifted leftward and the TMP0 is shifted rightward.

Although the architecture including both of the ring bus 102 and the ring bus 103 is shown as the first exemplary embodiment, an architecture provided with only the ring bus 102 may be employed.

In this case, the “Shift” should be calculated along with the shift direction of the ring bus 102.

And, the switching of addition/subtraction is not necessary, and the selecting action by the multiplexer 504 is not necessary.

In this architecture, though more shift actions of the ring bus 102 may be needed, the efficiency of using read-only parameters stored in a distributed way is well achieved.

### INCORPORATION BY REFERENCE

This application is based upon and claims the benefit of priority from International application No. PCT/JP2009/057020, filed on Mar. 30, 2009, the disclosure of which is incorporated herein in its entirety by reference.

### INDUSTRIAL APPLICABILITY

The present invention can be applied to a data processing apparatus, a data processing system, and a data processing method that perform parallel processing.

### REFERENCE SIGNS LIST

100 CP
101 PE
102 ring bus in clockwise direction
103 ring bus in anticlockwise direction
104 connection
105 shift register
106 DMEM
107 IMEM
121 ALU
122 splitting unit
123 cmpmv unit
201 de-blocking filter
202 actual frame memory
203 inter prediction unit
204 reference frame memory
205 intra prediction unit
206 switching unit
207 addition unit
208 decoding loop
300 macro block
301 sub block
302 edge
303 image pixel
401 bit right shifter
402 bit left shifter
403 inverter
404 AND unit
501 addition/subtraction unit
502 sign bit inverter
503 determination unit
504 multiplexer
600 global address
601 Addr_{IMEM}
602 POS_{IMEM}
603 boundary

1.-10. (canceled)

11. A data processing apparatus for processing in parallel with a plurality of processor elements, each of the processor elements having an internal memory storing read-only parameter data from a data memory in a distributed way, to transfer in parallel the read-only parameter data from the internal memory of one processor element to other processor elements through at least one ring bus, the data processing apparatus comprising:
a splitting unit that splits an address of the read-only parameter data in the data memory into a first part and a second part at a bit position corresponding to the number of the processor elements; and
a comparing unit that compares the number of shifting, on the at least one ring bus, of the read-only parameter data, which is taken from the internal memory at the address in accordance with the first part, with a difference between an own processor element position and a portion of the global address of the read-only parameter data to be accessed, the portion designating a position in the at least one ring bus of the processor element in which the read-only parameter data to be accessed is stored and corresponding to the second part, to cause the other processor elements to take the read-only parameter data according to a comparison result.

12. A data processing apparatus according to claim 11, wherein:
assuming that the number of the processor elements is NO_{PE}, the bit position is decided by log₂(NO_{PE}); and
the first part is a higher part of the address in the data memory standing on the left side of the bit position, and the second part is a lower side of the address in the data memory standing on the right side of the bit position.

13. A data processing apparatus according to claim 11,
wherein the splitting unit includes:
a logical right shifting unit that calculates a right shifted value by shifting rightward the address in the data memory by the number of bits corresponding to the number of the processor elements;
a logical left shifting unit that calculates a left shifted value by shifting leftward a fixed value by the number of bits corresponding to the number of the processor elements, the number of bits of the fixed value equaling to the number of bits of the address in the data memory, and all bits of the fixed value being 1;
an inverter that calculates an inverted value by inverting the left shifted value; and
a logical AND unit that calculates logical AND between the inverted value and the address in the data memory, as the second part.

14. A data processing apparatus according to claim 11,
wherein the at least one ring bus comprises two ring buses, shifting directions of the two ring buses being opposite to each other.

15. A data processing apparatus according to claim 14,
wherein the comparing unit includes:
an addition/subtraction unit that performs adding processing or subtracting processing between the number of shifting and the difference between the own processor element position and the portion of the global address of the read-only parameter data to be accessed which designates the position in the at least one ring bus of the processor element in which the read-only parameter data to be accessed is stored, the number of shifting being given an unsigned value, and the difference between the positions being given a signed value;
a switching unit that switches a processing in the addition/subtraction unit between the adding processing and the subtracting processing in accordance with a sign of the difference between the positions;
a determining unit that determines whether the output of the addition/subtraction unit is zero or not; and
a selecting unit that selects one ring bus of the two ring buses from which the read-only parameter data is taken in accordance with-the sign of the difference between the positions.

16. A data processing method for processing in parallel with a plurality of processor elements, each of the processor elements having an internal memory storing read-only parameter data from a data memory in a distributed way, to transfer in parallel the read-only parameter data from the internal memory of one processor element to other processor elements through at least one ring bus, the data processing method comprising:
splitting an address of the read-only parameter data in the data memory into a first part and a second part at a bit position corresponding to the number of the processor elements; and
comparing the number of shifting, on the at least one ring bus, of the read-only parameter data, which is taken from the internal memory at an address in accordance with the first part, with a difference between an own processor element position and a portion of the global address of the read-only parameter data to be accessed, the portion designating a position in the at least one ring bus of the processor element in which the read-only parameter data to be accessed is stored and corresponding to the second part, to cause the other processor elements to take the read-only parameter data according to a comparison result.

17. A data processing method according to claim 16,
wherein the splitting includes:
calculating a right shifted value by shifting rightward the address in the data memory by the number of bits corresponding to the number of the processor elements;
calculating a left shifted value by shifting leftward a fixed value by the number of bits corresponding to the number of the processor elements, the number of bits of the fixed value equaling to the number of bits of the address in the data memory, and all bits of the fixed value being 1;
calculating an inverted value by inverting the left shifted value; and
calculating logical AND between the inverted value and the address in the data memory, as the second part.

18. A data processing method according to claim 16,
wherein the at least one ring bus comprises two ring buses, shifting directions of the two ring buses being opposite to each other.

19. A data processing method according to claim 18,
wherein the comparing includes:
performing adding processing or subtracting processing between the number of shifting and the difference between the own processor element position and the part of the global address of the read-only parameter data to be accessed which designates the position in the ring of the processing element in which the read-only parameter data to be accessed is stored, the number of shifting being given an unsigned value, and the position difference being given a signed value;
switching a processing in the addition/subtraction step between the adding processing and the subtracting processing in accordance with a sign of the difference between the positions;
determining whether the output of the addition/subtraction unit is zero or not; and
selecting one ring bus of the two ring buses from which the parallel processing data is taken in accordance with the sign of the difference between the positions.

20. A data processing system for processing in parallel, comprising:
a data memory for storing data;
a plurality of processor elements for processing in parallel and splitting an address of read-only parameter data in the data memory into a first part and a second part at a bit position corresponding to number of the processor elements;
a plurality of internal memories storing the read-only parameter data from the data memory in a distributed way, each of the plurality of the internal memories being provided in accordance with each of the plurality of the processor elements;
at least one ring bus connected to the plurality of the processor elements for transferring the read-only parameter data taken from the internal memory at the address in accordance with the first part; and
a central processor for counting number of shifting of the read-only parameter data on the at least one ring bus,
wherein the processor elements put at the same time read-only parameter data onto the ring bus and take the read-only parameter data from the at least one ring bus based on a result of a comparison of the number of shifting with a difference between an own processor element position and a portion of the global address of the read-only parameter data to be accessed, the portion designating a position in the at least one ring bus of the processor element in which the read-only parameter data to be accessed is stored and corresponding to the second part.
